(19) United States
(12) Patent Application Publication
(10) Pub. No.: US 2015/0363741 A1
(43) Pub. Date: Dec. 17, 2015

(54) TASK ASSIGNMENT IN CROWDSOURCING

(71) Applicants: Praphul CHANDRA, (US); Arun KALYANASUNDARAM, Bangalore (IN); HEWLETT-PACKARD DEVELOPMENT COMPANY, L.P., West, Houston, TX (US)

(72) Inventors: Praphul Chandra, Bangalore (IN); Arun Kalyanasundaram, Bangalore (IN)

(21) Appl. No.: 14/761,368

(22) PCT Filed: Jan. 18, 2013
(86) PCT No.: PCT/IN2013/000036

§ 371 Date: Jul. 16, 2015

(51) Int. Cl. G06Q 10/06; G06Q 50/00

(52) U.S. Cl. CPC G06Q 10/063118; G06Q 50/01

(57) ABSTRACT

Systems and methods for task assignment in crowdsourcing are described. In one implementation, a method comprises receiving task information from a requester, the task information comprising at least details of a task, an accuracy level for task completion, and a budget for the task. The method further comprises computing expected costs of completing the task to achieve the accuracy level within the budget based on the task information, and recommending an assignment of the task to agents based on the computation.

### BACKGROUND

In a typical crowdsourcing environment, a task or problem can be assigned to a set of workers, also referred to as agents, some of whom may attempt the task. The subset of agents who attempt a given task is also referred to as the recruited crowd. The agents who attempt the task may be usually provided some remuneration in return for attempting the task and providing a solution. Once solutions are received from the agents, an aggregation technique, such as a majority vote, can be used to estimate a crowdsourcing solution to the task.

The accuracy of the crowdsourcing solution is generally determined as the ratio of correct answers to the total number of responses received from the recruited crowd. As the accuracy of the crowdsourcing solution is dependent on the capabilities and performance of the recruited crowd, i.e., recruited crowd quality, estimates of the recruited crowd quality can be used to improve task assignment and quality of the aggregate solution. When information about agent quality is available, such information may be used for optimal task assignment. Often, however, this is not the case in crowdsourcing environments. Information about agent quality is either distributed among requesters who post tasks or among other agents or co-workers. In such scenarios, referrals may be used to find high quality agents.

### BRIEF DESCRIPTION OF FIGURES

The detailed description is provided with reference to the accompanying figures. In the figures, the left-most digit(s) of a reference number identifies the figure in which the reference number first appears. The same numbers are used throughout the figures to reference like features and components.

FIG. 1 illustrates an example network environment implementing a crowdsourcing system, in accordance with principles of the present subject matter.

FIG. 2 illustrates an example method for task assignment, in accordance with principles of the present subject matter.

FIG. 3 illustrates another example network environment for task assignment, in accordance with principles of the present subject matter.

### DETAILED DESCRIPTION

Systems and methods for task assignment in crowdsourcing are described herein. When tasks are assigned to agents through a crowdsourcing environment, the quality or accuracy of the aggregated solution depends strongly on the quality of the recruited crowd. In cases where the ground truth or correct solution of a task is not known beforehand, result-aggregation can, at best, estimate the confidence in the aggregated answer, for example, by taking into account the variance or entropy in the agent responses. Such measures of confidence or accuracy can be calculated only after the task has been attempted by the agents at a cost. However, the accuracy of a solution can be improved by improving the recruited crowd quality during task assignment even before incurring any costs. Typically, however, tasks are assigned in either a random manner or on a first-come-first-serve basis. As a result, there is little or no control on the recruited crowd quality, leading to reduced efficiency and usability of crowdsourcing platforms.

The recruited crowd quality itself is a function of the quality of agents who constitute the recruited crowd. Typically, the information about agent quality is either distributed among requesters who post tasks or among other agents. Such information is not readily available for estimating the recruited crowd quality. In such scenarios, referrals can be used to find high quality agents. Through referrals, agents or other requesters can refer a task to other agents who they think have the required capability to complete the task. However, incentives may have to be given to the agents who provide the referrals to ensure that they provide good referrals. Thus, the referrals may themselves have a non-zero cost that adds to the cost of task completion, while the budget for the task is usually fixed.

Hence, while referral based task assignment may be effective for certain tasks, it may not be cost effective in all scenarios. Further, in case of referral based task assignment, the given budget has to be optimally allocated, between being used for obtaining referrals and being used to pay the agents who complete the tasks, to maximize accuracy of the results.

The systems and methods described herein help to determine dynamically, for a given task and desired solution accuracy, the conditions under which it is better to spend a part of the available budget on improving task assignment by using referrals. Further, the systems and methods help to determine the task assignment model that is best suited for an underlying agent pool for the given task. In case referral based task assignment is to be used, the systems and methods also provide an upper bound of the amount to be spent on referrals, referred to as a referral payment, to achieve greater result accuracy.

In one implementation, a crowdsourcing system receives task information, such as details of a task to be posted, a threshold level of accuracy desired, agent payment for completion of the task, and total budget for the task, from a user, also referred to as a requester. Further, in one scenario, the requester may provide agent criteria including minimum qualifications of an agent allowed to attempt the task. The qualifications can include, for example, educational qualifications, previous experience, demographics, etc. Based on the agent criteria, the system can perform a pre-screening of the agents to form the agent pool for task assignment. In another scenario, the requester may not provide any agent criteria, and the complete agent pool available to the system may be used for the task assignment.

Further, the system may determine a task assignment model to be used for task assignment based on the task information and an agent capability distribution. In one implementation, the system compares expected costs to obtain a solution of the desired accuracy using different task assignment models and recommends the task assignment model with the lowest expected cost for task assignment. The different task assignment models can include, for example, oracle assignment, random assignment, and referral based task assignment. Referral based task assignment can further include referral assignment, random-referral hybrid assignment and oracle-referral hybrid assignment.

In the oracle assignment, the system or the requester is aware of the individual capabilities of the agents, for example, based on previous performance. Hence, the task can be directly assigned to the agents with the required capabilities. In the random assignment, there is no prior knowledge of individual agent capabilities, and so, the task is assigned at random to the agents. In the referral assignment, all assignments are based on referrals, and so, incur both referral cost and cost of task completion. Further, in case of hybrid assignments, an initial seed set of agents is assigned the task either based on random assignment or oracle assignment. The seed set can then refer agents for completion of the task.

Amongst the above assignment models, while the oracle assignment is usually the most cost effective, it may not be applicable in cases where information about individual capabilities of all agents or enough number of agents is not known. In the other assignment models, the expected cost depends also on the agent capability distribution.

The agent capability distribution may be known based on past performance of the agents or provided by the requester as a part of task information or may be assumed by the system for different tasks. For example, the agent capability distribution can be modeled as any of a discrete uniform distribution, continuous uniform distribution, exponential distribution and normal distribution with different mean values and variance values.

Further, in case a referral based task assignment is recommended, the systems and methods can also suggest an upper bound on the amount to be paid for a referral, also referred to as referral payment, to obtain the solution with the desired accuracy.

The systems and methods can thus recommend a task assignment model and an upper bound on referral payment in case referral based task assignment is recommended. Hence, the task can be optimally assigned to achieve the desired level of accuracy within the specified budget. Accordingly, the efficiency, reliability, and usability of crowdsourcing platforms can be increased.

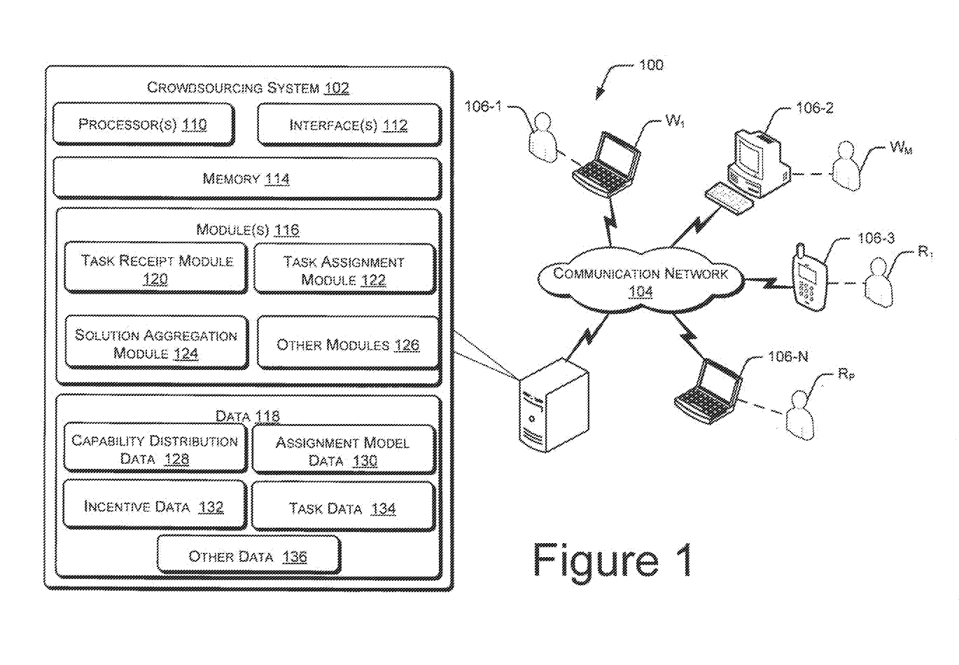

The above systems and methods are further described in conjunction with FIGS. 1, 2 and 3. It should be noted that the description and figures merely illustrate the principles of the present subject matter. It will thus be appreciated that various arrangements that embody the principles of the present subject matter, although not explicitly described or shown herein, can be devised from the description and are included within its scope. Furthermore, all examples recited herein are only for pedagogical purposes to aid the reader in understanding the principles of the present subject matter. Moreover, all statements herein reciting principles, aspects, and embodiments of the present subject matter, as well as specific examples thereof, are intended to encompass equivalents thereof.

FIG. 1 illustrates a networking environment 100 implementing a crowdsourcing system 102, according to an implementation of the present subject matter. The network environment 100 may be a public networking environment or a private networking environment. The crowdsourcing system 102 can be configured to host a crowdsourcing platform for requesters to post tasks, assign the tasks to agents, receive responses for the tasks from the agents and estimate an aggregated solution. In an implementation, the crowdsourcing system 102, referred to as system 102 hereinafter, may be implemented as, but is not limited to, a server, a workstation, a computer, and the like.

For the purpose of crowdsourcing, the system 102 is communicatively coupled over a communication network 104 with a plurality of user devices 106-1, 106-2, 106-3, . . . 106-N using which requesters R₁, R₂, R₃, . . . R_{P} may post tasks and agents W₁, W₂, W₃, . . . , W_{M} may attempt to provide solutions for posted tasks. It will be understood that requesters and agents may not be mutually exclusive, and that a user may be a requester for one task and an agent for another.

The user devices 106-1, 106-2, 106-3, . . . , 106-N, may be collectively referred to as user devices 106, and individually referred to as a user device 106 hereinafter. The user devices 106 may include, but are not restricted to, desktop computers, laptops, smart phones, personal digital assistants (PDAs), tablets, and the like. In an implementation, an agent W and a requester R may be registered individuals or non-registered individuals intending to use the system 102. Further, an agent may attempt a task online or may attempt the task offline and later submit the solution online.

The user devices 106 are communicatively coupled to the system 102 over the communication network 104 through one or more communication links. The communication links between the user devices 106 and the system 102 may be enabled through a desired form of communication, for example, via dial-up modem connections, cable links, and digital subscriber lines (DSL), wireless or satellite links, or any other suitable form of communication through the communication network 104.

The communication network 104 may be a wireless network, a wired network, or a combination thereof. The communication network 104 can also be an individual network or a collection of many such individual networks, interconnected with each other and functioning as a single large network, e.g., the Internet or an intranet. The communication network 104 can include different types of networks, such as intranet, local area network (LAN), wide area network (WAN), the internet, and such. The communication network 104 may either be a dedicated network or a shared network, which represents an association of the different types of networks that use a variety of protocols, for example, Hypertext Transfer Protocol (HTTP), Transmission Control Protocol/Internet Protocol (TCP/IP), etc., to communicate with each other. The communication network 104 may also include individual networks, such as, but not limited to, Global System for Communication (GSM) network, Universal Telecommunications System (UMTS) network, Long Term Evolution (LTE) network, etc. Depending on the terminology, the communication network 104 includes various network entities, such as base stations, gateways, and routers; however, such details have been omitted to maintain the brevity of the description. Further, it may be understood that the communication between the system 102, the user devices 106, and other entities may take place based on the communication protocol compatible with the communication network 104.

In an implementation, the system 102 includes processor(s) 110. The processor(s) 110 may be implemented as microprocessors, microcomputers, microcontrollers, digital signal processors, central processing units, state machines, logic circuitries, and/or any devices that manipulate signals based on operational instructions. Among other capabilities, the processor(s) 110 are configured to fetch and execute computer-readable instructions stored in the memory. The functions of the various elements shown in FIG. 1, including any functional blocks labeled as processor(s), may be provided through the use of dedicated hardware as well as hardware capable of executing software in association with appropriate software. Moreover, the term processor may implicitly include, without limitation, digital signal processor (DSP) hardware, network processor, application specific integrated circuit (ASIC), field programmable gate array (FPGA), read only memory (ROM) for storing software, random access memory (RAM), non-volatile storage. Other hardware, conventional and/or custom, may also be included.

The system 102 also includes interface(s) 112. The interface(s) 112 may include a variety of software and hardware interfaces that allow the system 102 to interact with the user devices 106. Further, the interface(s) 112 may enable the system 102 to communicate with other devices, such as network entities, web servers and external repositories. The interface(s) 112 may facilitate multiple communications within a wide variety of networks and protocol types, including wire networks, for example, LAN, cable, IP, etc., and wireless networks, for example, WLAN, cellular, satellite-based network, etc.

Further, the system 102 includes memory 114, coupled to the processor(s) 110. The memory 114 may include any computer-readable medium known in the art including, for example, volatile memory (e.g., RAM), and/or non-volatile memory (e.g., EPROM, flash memory, etc.).

Further, the system 102 includes modules 116 and data 118. The modules 116 may be coupled to the processor(s) 110. The modules 116, amongst other things, may include routines, programs, objects, components, data structures, and the like, which perform particular tasks or implement particular abstract data types. The data 118 serves, amongst other things, as a repository for storing data that may be fetched, processed, received, or generated by one or more of the modules 116. Although the data 118 is shown internal to the system 102, it may be understood that the data 118 can reside in an external repository (not shown in the figure), which may be coupled to the system 102. In such a case, the system 102 may communicate with the external repository through the interface(s) 112 to obtain information from the data 118.

In an implementation, the modules 116 of the system 102 include a task receipt module 120, a task assignment module 122, a solution aggregation module 124, and other module(s) 126. In an implementation, the data 118 of the system 102 includes capability distribution data 128, assignment model data 130, incentive data 132, task data 134, and other data 136. The other module(s) 126 may include programs or coded instructions that supplement applications and functions, for example, programs in the operating system of the system 102, and the other data 136 may comprise data corresponding to one or more module(s) 116.

In an implementation, users including agents W and requesters R may be authenticated for connecting to the system 102 and attempting a task or posting a task. For the purpose of authentication, the users may have to register with the system 102, based on which login details, including user IDs and passwords, may be given to the users. In operation, a user may enter his login details on his user device 106, which may be communicated to the system 102 for authentication. The system 102 may be configured to authenticate the users, and allow or disallow the users from communicating with the system 102 based on the authentication.

Further, once a requester, say R₁, has access to the system 102, the requester can provide a task for posting by giving task information to the system 102. The task receipt module 120 receives the task information including details of a task to be posted, a threshold level of accuracy desired, task payment for completion of the task and total budget for the task. Further, in one scenario, the requester R₁ may provide agent criteria including minimum qualifications of an agent allowed to attempt the task. The qualifications can include, for example, educational qualifications, previous experience, demographics, etc. The task receipt module 120 can save the task information and the agent criteria in the task data 134 for subsequent retrieval and use. Based on the task information, the task assignment module 122 can recommend a task assignment model to be used for achieving the specified accuracy level.

In one implementation, the task assignment module 122 recommends a task assignment model based on the complete agent pool available to the system 102. In another implementation, the task assignment module 122 can perform a pre-screening of the available agents based on the agent criteria to form the agent pool for task assignment.

Further, the task assignment module 122 may determine a task assignment model to be used for assigning the task to the agent pool based on the task information and an agent capability distribution. The agent capability distribution refers to a distribution function modeling distribution of agent capabilities in the agent pool. Various distribution functions may be available or modeled from capability distribution data 128. In one implementation, the system 102 may determine the agent capability distribution based on past performance of the agents in the agent pool. In another implementation, the requester may select an agent capability distribution, for example, based on past experience. In yet another implementation, the agent capability distribution may be randomly selected.

In one implementation, the task assignment module 122 can compare an expected cost to obtain a solution of the desired accuracy using different task assignment models and recommend the task assignment model with the lowest expected cost for task assignment.

The different task assignment models can include, for example, oracle assignment, random assignment, and referral based task assignment. Referral based task assignment can further include referral assignment, random-referral hybrid assignment and oracle-referral hybrid assignment. In one implementation, the different task assignment models may be retrieved from assignment model data 130.

Consider a task-i and a pool of n agents each with capability θᵢⱼ, where θᵢⱼ is a measure of how capable agent-j is for task-i. Suppose agent-j is paid sᵢ for completing task-i and paid rᵢ for referring another agent k for task-i in order to maximize the accuracy of the crowdsourcing solution, it may be desirable to use only those agents with θᵢⱼ>Θ. The value of the parameter Θ depends on a solution aggregation algorithm used and task design, since each result aggregation algorithm might have a minimum agent capability level to accurately determine the result. For example, whenever a simple majority vote is used for aggregating agents' responses, the relationship between the probability that the aggregated answer (yᵢ^{<aggr>}) equals the ground truth (yᵢ^{<gt>}) for a homogeneous recruited crowd containing agents each with capability Θ, where z agents attempt the task is as shown in equation 1:

$$Pr ( {y}_{i}^{< aggr >} = {y}_{i}^{< gi >} ) = {\sum }_{m = 0}^{m = \frac{z}{2}} ( \begin{matrix}z \\ m\end{matrix} ) {{Θ}^{z - m} ( 1 - Θ )}^{m} \qquad ( 1 )$$

Thus, equation (1) can be used by the task assignment module 122 to translate a desired expected accuracy to desired crowd quality with parameters Θ and z if majority voting algorithm is used. If desired accuracy is specified as a minimum threshold, then the desired crowd quality can be expressed as a threshold Θ and the number of agents z with capability greater than this threshold Θ, to achieve the desired accuracy in expectation. Translating expected accuracy requirements to a threshold agent capability as above, makes analysis easy without loss of generality. In the simplest case, the task assignment module 122 is able to translate accuracy requirements to a single Θ. In more involved scenarios, a certain number of agents with Θ₁ may be used, while accepting some other agents with Θ₂ and so on. In such cases, each requirement can be treated independently. Thus, a homogeneous recruited crowd can be selected from a heterogeneous agent pool.

In the random assignment model, it is assumed that the task assignment module 122 is not aware of the individual agent capabilities and so agents are assigned the task at random. So, the complete available budget Bⱼ is spent on paying the agents for completing the task. Thus, the number of agents mᵢ that can attempt the task-i, is given by equation 2:

$${m}_{i} = ⌊ \frac{{B}_{i }}{{s}_{i}} ⌋ \qquad ( 2 )$$

In the random assignment model, the probability p_{Θ} of picking an agent, with capability greater than the threshold capability Θ, depends on the capability distribution. If X represents the random variable representing the experiment of randomly picking agents from the agent pool till z agents with capability greater than Θ are selected, then X follows a negative binomial distribution as shown in equation 3 and the expected value of X can be computed as shown in equation 4.

$$\begin{matrix}P ( X = x ) = ( \begin{matrix}x - 1 \\ z - 1\end{matrix} ) {{p}_{Θ}^{z} ( 1 - Θ )}^{n - z} & ( 3 ) \\ E [ x ] = \frac{z}{{p}_{Θ}} & ( 4 )\end{matrix}$$

If the expected value of X is less than mᵢ as determined from equation 2, random assignment can be selected to meet the accuracy requirements. An alternate way of expressing this is based on a comparison of the estimated cost of achieving a desired accuracy for task-i and the budget Bᵢ available. As described, a desired accuracy translates into a desired Θ and z. Using Equation 4, the expected total cost can be computed as shown in equation 5:

$$E [ {C}_{i}^{〈 rand 〉} ] = \frac{z}{{p}_{Θ}} {s}_{i} \qquad ( 5 )$$

Therefore, the task assignment module 122 may select the random task assignment as long as E[Cᵢ] is less than the budget available for task i.

In the oracle assignment model, it is assumed that the task requester or the system 102 knows θᵢⱼ for all task-i-agent-j pairs at no cost, for example, based on past performance of the agents. Since the most optimal agents for a given task-i can be selected directly, the cost equation for the oracle task assignment will be as shown in equation 6:

Cᵢ^{(oracle)=z·s}ᵢ (6)

Thus, the system 102 or requester R can directly select z-agents with θᵢⱼ>Θ and assign the task to them assuming that the agent pool contains at least z agents with θᵢⱼ>Θ.

The random task assignment and the oracle task assignment represent two extreme scenarios. While the random assignment requires no information about θᵢⱼ, the oracle task assignment assumes complete information of θᵢⱼ for all ij pairs. Between these two extremes, lies a scenario where information among θᵢⱼ is distributed among dome of the agents or requesters who can act as referral nodes. For example, the agents W may be aware of the θᵢⱼ of their friends or co-agents and the requesters R may know θᵢⱼ of the agents who they have interacted with in the past. This scenario can be modeled as a directed graph where each node represents a referral node and an edge from node u to node v indicates that node-u knows θᵢᵥ for a task-i.

When a referral is made by a node, it can be represented as an edge, which joins the node with a referred node being activated. Path referrals, i.e., a sequence of edge activations, are also possible. For the referral based assignment, an initial set of nodes, referred to as seed set, may be first activated through random or oracle based assignment. This seed set may then refer agents with the desired threshold capability G. Thus, the overall process of task assignment appears as a seed set of nodes activated extrinsically, through random or oracle assignment, and then, a series of edge activations leading to node activations depicting the role of referrals.

Here, it is assumed that when agents are offered an incentive to refer, they make good referrals. i.e., when asked to refer an agent with θᵢⱼ greater than Θ, the agent always does so due to the incentive. For this, it is assumed that the referral payment scheme is incentive compatible for rational agents to refer agents with capability above a desired value. Such incentive compatible referral payment schemes can be designed as is known in the art and newer incentive compatible schemes can also be used as they become known in the art. In one implementation, various incentive schemes may be saved as incentive data 132 and the requester R₁ may select a suitable incentive scheme or provide their own incentive scheme for a particular task.

Further, the incentive scheme may be such that it is incentive compatible for an agent W to limit the maximum number of referrals the agent W makes. Such incentive schemes may be used, for example, to additionally make the referral mechanism budget feasible. In another implementation, the requester R₁ may specify the maximum number of referrals an agent can make, for example, to ensure more wide-spread participation.

Since each referral comes at a cost rᵢ, the task assignment module 122 can further determine how much of the task budget Bᵢ is to be used towards referrals. Considering a scenario where all agents who attempt the task must be referred, i.e., a referral assignment, the total cost of task completion can be computed as shown in equation 7:

Cᵢ^{(refer)}=z·(sᵢ+rᵢ) (7)

Comparing equation 7 with equation 6, it can be inferred that a referral assignment incurs an additional cost of z·rᵢ in task allocation to achieve the same performance as oracle assignment under the assumption that all referrals are good. Further, comparing equation 7 with equation 5, it can be inferred that a referral assignment costs less than a random assignment for a given accuracy/crowd-quality level, when the expected cost of referral is less than the expected cost of random assignment. This can be simplified as shown in equation 8.

$${C}_{i}^{〈 refer 〉} < E [ {C}_{i}^{〈 rand 〉} ] \\ ∴ z \cdot ( {s}_{i} + {r}_{i} ) < \frac{z}{{p}_{Θ}} {s}_{i} \\ ∴ {p}_{Θ} < \frac{1}{1 + \frac{{r}_{i}}{{s}_{i}}} \qquad ( 8 )$$

Equation 8 treats rᵢ as an independent variable and p_{Θ} as a dependent variable. Thus, using equation 8, the task assignment module 122 can determine when it is better to use a referral assignment with a given referral bonus or payment (rᵢ) as compared to a random assignment. Thus, a referred task assignment with referral budget (z·rᵢ) is more cost effective than random assignment, when the probability of picking an agent with capability greater than Θ is lower than a certain threshold value. This intuitively implies that if a task is such that there are very few agents in the agent pool capable of completing it well, it is cost effective to spend a part of the budget to find these agents. On the other hand, if there are a lot of agents capable of solving a task accurately, it is better to just randomly pick agents from the pool rather than spend the budget on referrals.

Furthermore, equation 8 can be re-written such that p_{Θ} is an independent variable and r; is a dependent variable, as shown in equation 9:

$${r}_{i} < \frac{1 - {p}_{Θ}}{{p}_{Θ}} {s}_{i} \qquad ( 9 )$$

Based on equation 9, the task assignment module 122 can compute the upper bound of the referral budget available for a referral mechanism to outperform random task assignment. In other words, if the referral mechanism can ensure that agents make good referrals when offered an incentive less than the upper threshold of equation 9, a referred task assignment can outperform random task-assignment. Intuitively, it says that when setting a referral bonus, the maximum available referral bonus for an agent depends on how difficult it is to find agents with a desired capability. As the probability of finding the agents with the desired capability reduces, the upper bound on the referral bonus that can be provided increases, as shown in table 1 below;

TABLE 1
Variation in upper bound on rᵢ with p_{Θ}

| | | | | | | | |
|---|---|---|---|---|---|---|---|
| rᵢ | 0 | sᵢ/4 | sᵢ/2 | sᵢ | 2sᵢ | 4sᵢ | ∞ |
| p_{Θ} | 1 | 0.8 | 0.67 | 0.5 | 0.33 | 0.2 | ⁰ |

The above discussed referral assignment model assumed that all task assignments are via referrals. However, in most crowdsourcing scenarios, there is an initial set of agents which can attempt the task without referrals. This initial set of agents, or seed set, can then refer other agents. This type of task-assignment, which contains both referred and non-referred agents, is referred to as a hybrid assignment. Hybrid assignment can be either a random-referral hybrid assignment or an oracle-referral hybrid assignment.

In the random-referral hybrid assignment, the seed set of agents attempting a task is chosen at random, and the budget allocation for referral payment depends on the size of the seed set. Let α represent the size of the seed set. Since the seed set is selected randomly, not all α agents will have a capability greater than Θ By picking α agents randomly, the expected number of agents who will have capability greater than Θ would be α·p_{Θ}. Hence, the number of agents that still need to be recruited via referrals to achieve the desired quality would be (z−αp_{Θ}) and the total cost of task completion would be as shown in equation 10:

Cᵢ^{(rand+refer)}=αsᵢ+(z−αp_{Θ})(sᵢ+rᵢ) (10)

Further, it can be computed when the random-referral hybrid task assignment would cost less than a pure random task assignment for a given accuracy/crowd-quality level as shown in equations 11 and 12 below:

$$\begin{matrix}E [ {C}_{i}^{〈 rand + refer 〉} ] < E [ {C}_{i}^{〈 rand 〉} ] \\ α {s}_{i} + ( z - α {p}_{Θ} ) ( {s}_{i} + r ) < \frac{z}{{p}_{Θ}} {s}_{i} & ( 11 ) \\ ∴ {r}_{i} < \frac{1 - {p}_{Θ}}{{p}_{Θ}} {s}_{i} & ( 12 )\end{matrix}$$

It can be observed that equation 12 is exactly the same as equation 9. This is because equations 10-12 made no assumptions about the value of α and are thus valid for α=0 too. When α=0, it implies that there is no seed set and all assignments are through referrals. Hence, equation 10 reduces to equation 7 and hence, equation 12 is the same as equation 9. Further, even though the per-agent referral payment is still rᵢ, the referral budget in this hybrid case is (z−α·p_{Θ})·rᵢ, which is less than the referral budget for the all-referral case for α>0. Thus, the referral budget available for a hybrid task assignment to outperform random task assignment is (z−α·p_{Θ})·rᵢ where the upper bound on rᵢ is given by equation 12. Thus, the larger the seed set, the lower the overall referral budget. However, the incentive constraint on each referrer to make a good referral stays the same and hence, the constraint on the design of the referral mechanism stays the same.

In the oracle-referral hybrid assignment, as before, α represents the size of the seed set. Here, since the seed set is selected based on available knowledge, all α agents will have capability greater than Θ. Hence, the number of agents that still need to be recruited via referrals to achieve the desired quality would be (z−α) and the total cost of task completion can be computed as shown in equation 13:

Cᵢ^{(oracle+refer)}=αsᵢ+(z−α)(sᵢ+rᵢ) (13)

Further, it can be computed when the oracle-referral hybrid task assignment costs less than a pure random task assignment for a given accuracy I crowd-quality level as shown below in equation 14.

$$E ⌊ {C}_{i}^{〈 oracle + refer 〉} ⌋ < E ⌊ {C}_{i}^{〈 rand 〉} ⌋ \\ {r}_{i} < \frac{1 - {p}_{Θ}}{{p}_{Θ}} {s}_{i} \frac{1}{1 - \frac{α}{z}} \qquad ( 14 )$$

It can be observed that equation 14 is similar to equation 9 except for the scaling factor of the seed set. In the limiting case when α=0, i.e., when there is no seed set, equation 14 reduces to equation 9 as expected. As α grows with larger seed sets, a dual effect occurs whereby the net referral budget (z−α)·rᵢ falls and the per-agent referral bonus available for incentivizing good referral increases. Thus, the advantage of an oracle seed set gets reflected in additional referral bonus that can be offered to each agent and can also be used to relax the incentive constraints for design of a referral mechanism. Intuitively, this happens because, unlike the random-referral hybrid case, there is no cost to finding a seed set.

In the above discussed task assignment models, the conditions under which referral based mechanisms are to be used and the referral payment amounts depend on the capability distribution reflected in p_{Θ}, which is the probability of picking an agent with θᵢⱼ greater than Θ. If X is a random variable which represents the capabilities of agents in the given pool, then X can take values between 0 and 1. Given a capability distribution with probability density function f and a cumulative distribution function (CDF) F, p_{Θ} can be written as shown in equation 15 below:

$${p}_{Θ} = P ( X > Θ ) = 1 - P ( X \leq Θ ) = 1 - Fx ( Θ ) = 1 - {\int }_{0}^{Θ} f ( x ) d x \qquad ( 15 )$$

Since there are a finite number of agents, X is a discrete random variable. However, it is appreciated that for ease of interpretation, X may be modeled using various continuous distribution functions as well as discrete distribution functions. In operation, the agent capabilities could fall into a set of discrete values. For example, there could be a set of ten discrete values or categories—{0.1, 0.2, . . . , 1} and each agent's capability can fall into any one of these categories based on what is the minimum value in the set that the capability is less than.

In one scenario, the capability distribution may be assumed to follow a continuous uniform distribution. Such a distribution signifies that the probability that a randomly picked agent has a given capability is a constant. In other words a uniform capability distribution reflects the type of task which has an equal number of capable and incapable agents. Since X is in the range [0,1], the probability density function, f(x) is simply 1/(1-0)=1, Therefore equation 15 reduces to:

$${p}_{Θ} = 1 - {\int }_{0}^{Θ} d x = 1 - Θ$$

Using the above in equation 9, the upper bound on rᵢ for which a referred assignment is better than a random assignment, with Θ being the independent variable, can be computed as:

$${r}_{i} < \frac{Θ}{1 - Θ} {s}_{i}$$

In other words, if rᵢ^{<max>} is the maximum value of r below which referred task assignment is more cost effective than random assignment, then the above equation can be re-written as shown in equation 16:

$${r}_{i}^{〈 max 〉} = \frac{Θ}{1 - Θ} {s}_{i} \qquad ( 16 )$$

In another scenario, the capability distribution may be assumed to follow an exponential distribution. This reflects the type of tasks for which only a small fraction of agents are capable of accurately completing the task. A rate parameter λ can be used to denote the size of the fraction of agents with a desired capability. The higher the value of λ, the smaller the fraction of highly capable agents.

In yet another scenario, the capability distribution may follow a normal distribution. This reflects the type of tasks where a majority of agent capabilities are almost equal with some variance. For example, a large fraction of the population may be clustered around its mean (μ) and one standard deviation (σ). Further, the mean and variance for the normal distribution can be selected as it most closely models different agent capability distributions for a given task.

For example, a low mean and low variance distribution may be used when most agents do not have the right set of capabilities for the given task. The probability mass of the distribution is concentrated in a low θᵢⱼ region. Such a task is unlikely to get completed with high accuracy levels with a random task assignment since there are very few, if any, agents who can complete the task correctly. So, either oracle task assignments or referral based task assignments are more suitable for such tasks, since it is rational to spend a budget on finding agents with the right skill set rather than randomly assigning the task.

In another example, a high mean and low variance distribution may be used when most agents have the right set of capabilities for the given task. The probability mass of the distribution is concentrated in a high θᵢⱼ region. Such a task is likely to get completed with high accuracy levels with a random task assignment since there are many agents who can complete the task correctly, and a referral based assignment may not be required.

In yet another scenario, relative capabilities can be used to generalize the capability distribution, for example, where the task is to be done by agents in the top 10 percentile of the agent pool, instead of specifying the absolute value of Θ. The expected cost of the task for a required relative capability of agents may the same irrespective of the distribution. Therefore, p_{Θ} can be used as the independent variable instead of Θ, since the expected cost and referral budget may remain the same for a given value of p_{Θ} across all types of capability distributions.

In one implementation, the requester R₁ may specify an agent capability distribution to be used for selection of a task assignment model. In another implementation, based on the task information, the task assignment module 122 may provide capability distribution information, from capability distribution data 128, to the requester R for selecting a capability distribution to be used for recommending a task assignment model.

Thus, based on the above discussed computations, the task assignment module 122 can recommend a task assignment model to the requester and an upper bound on the referral payment if referral based assignment is recommended. Further, the requester can accept the task assignment model recommended, and suggest a referral amount based on the upper bound if applicable. Accordingly, the task assignment module 122 can assign tasks to agents, inform the agents as to whether they can refer other agents for task assignment, and inform the agents on the referral payment amount. Thus, a recruited crowd of desired quality can be enlisted to perform the task and achieve the specified accuracy level.

The recruited crowd can then attempt the task and provide the solutions to the solution aggregation module 124. The solution aggregation module can use various mechanisms, such as, for example, majority vote mechanisms to determine an aggregate solution, also referred to as a crowdsourced solution, for the task. The solution aggregation module 124 can then provide the crowdsourced solution to the requester R₁.

The system 102 can thus help a requester to efficiently and reliably select the recruited crowd and provide a referral payment conducive to achieving a desired accuracy within a specified budget.

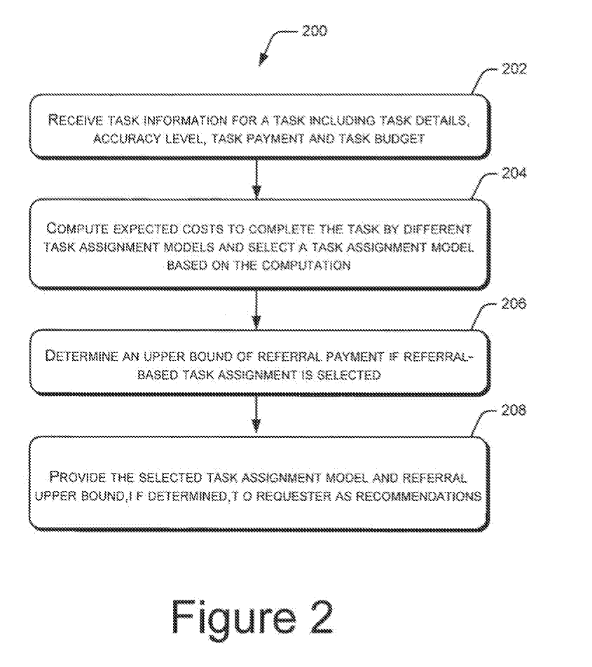

FIG. 2 illustrates a method 200 for task assignment in crowdsourcing, according to an implementation of the present subject matter. The order in which the method 200 is described is not intended to be construed as a limitation, and some of the described method blocks can be combined in any order to implement the method 200, or an alternative method. Additionally, individual blocks may be deleted from the method 200 without departing from the scope of the subject matter described herein.

Furthermore, the method 200 can be implemented by processor(s) or computing devices in any suitable hardware, software, firmware, or combination thereof. The method 200 may be executed based on instructions stored on a non-transitory computer readable medium as will be readily understood. The non-transitory computer readable medium may include, for example, digital data storage media, digital memories, magnetic storage media, such as a magnetic disks and magnetic tapes, hard drives, or optically readable digital data storage media.

Further, although the method 200 for task assignment in crowdsourcing may be implemented in a variety of computing devices working in different communication network environments for crowdsourcing; in an embodiment described in FIG. 2, the method 200 is explained in context of the aforementioned crowdsourcing system 102, for the ease of explanation.

At block 202, task information is received from a requester. The task information may include, for example, details of a task to be posted, a threshold level of accuracy desired, a task payment for completion of the task and a total budget for the task. In one implementation, the task receipt module 120 receives the task information. Further, the requester may also provide agent criteria, such as education qualifications and demographics, to select an agent pool for task assignment.

At block 204, expected costs for completing the task using different task assignment models are computed and compared. In one implementation, the task assignment module 122 computes and compares the expected cost based on the received task information and an agent capability distribution. The task assignment module 122 may receive the agent capability distribution from the requester or may retrieve the agent capability distribution from the capability distribution data. Accordingly, the task assignment module 122 may recommend a task assignment model from an oracle assignment, a random assignment, a referral assignment and a hybrid assignment. In the hybrid assignment, a seed set of agents can be selected based on one of the oracle assignment and the random assignment. The task can be then assigned to the seed set for referral and completion of the task. Based on how the seed set is selected, the hybrid assignment can be referred to as a random-referral hybrid assignment or an oracle-referral hybrid assignment.

At block 206, an upper bound of referral payment is determined. If a referral based task assignment is recommended at block 204. In one implementation, the task assignment module 122 determines the upper bound of referral payment such that a crowdsourced solution of specified accuracy can be achieved within the given budget.

At block 208, the selected task assignment model and upper bound of referral, if determined, are provided to the requester as recommendations. In one implementation, the task assignment module 122 recommends use of the selected task assignment model to the requester.

Further, based on the recommendations, the requester can select the task assignment model to be used and can specify the referral payment to be given. Accordingly, the recruited crowd can be selected, the task can be assigned to agents in the recruited crowd, and the agents can be informed of the task payment and referral payment applicable, for example, by the task assignment module 122. The agents in the recruited crowd can then attempt the task and post the solutions, which can be aggregated to obtain the crowdsourced solution, for example, by the solution aggregation module 124.

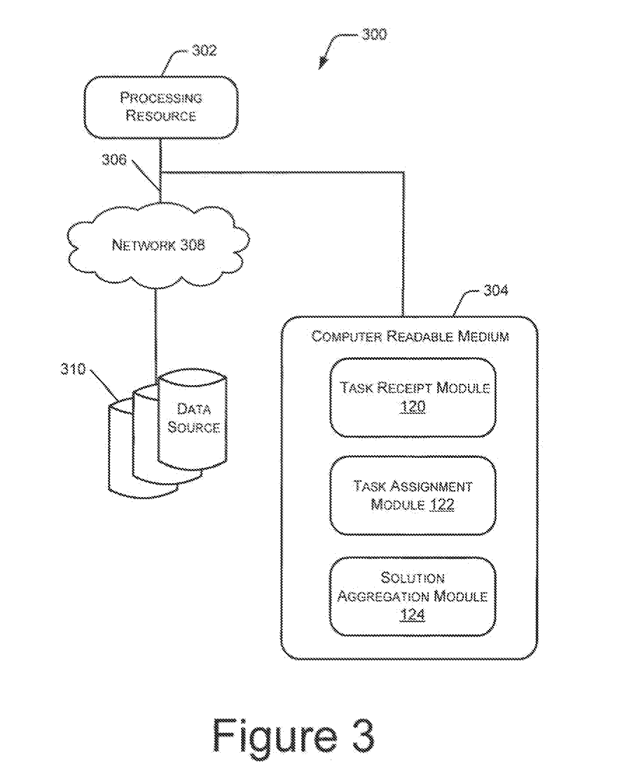

FIG. 3 illustrates another example network environment 300 for task assignment, in accordance with principles of the present subject matter. The network environment 300 may be a public networking environment or a private networking environment. In one implementation, the network environment 300 includes a processing resource 302 communicatively coupled to a computer readable medium 304 through a communication link 306.

For example, the processing resource 302 can be a computing device, such as a server, a laptop, a desktop, a mobile device, and the like. The computer readable medium 304 can be, for example, an internal memory device or an external memory device. In one implementation, the communication link 306 may be a direct communication link, such as any memory read/write interface. In another implementation, the communication link 306 may be an indirect communication link, such as a network interface. In such a case, the processing device 302 can access the computer readable medium 304 through a network 308. The network 308, like the network 104, may be a single network or a combination of multiple networks and may use a variety of different communication protocols.

The processing resource 302 and the computer readable medium 304 may also be communicatively coupled to data sources 310 over the network 308. The data sources 310 can include, for example, databases and computing devices. The data sources 310 may be used by the requesters and the agents to communicate with the processing resource 302.

In one implementation, the computer readable medium 304 includes a set of computer readable instructions, such as the task receipt module 120, the task assignment module 122 and the solution aggregation module 124. The set of computer readable instructions can be accessed by the processing resource 302 through the communication link 306 and subsequently executed to perform acts for task assignment in crowdsourcing.

For example, the task receipt module 120 can receive task information, including at least details of a task, an accuracy level for task completion and a budget for the task, from a requester. Further, the task assignment module 122 can compute expected costs of completing the task to achieve the accuracy level within the budget based on the task information and an agent capability distribution. The agent capability distribution may be received by the processing resource 302 from a user or from the data sources 310 over the network 308 or from the computer readable medium 304.

Based on the computation of the expected costs, the task assignment module 122 can recommend an assignment of the task to agents. In one implementation, the assignment recommended may be one of a random assignment, an oracle assignment, a referral assignment, a random-referral hybrid assignment and an oracle-referral hybrid assignment, as discussed previously. Further, in case a referral based assignment is recommended for completing the task, the task assignment module 122 can determine an upper bound on a referral payment for the task, as also discussed previously.

The agents to whom the task is assigned can then provide solutions to the processing resource 302. The processing resource 302 can access the solution aggregation module 124 of the computer readable medium 304 to estimate an aggregated solution and provide it to the requester.

Although embodiments for task assignment in crowdsourcing have been described in language specific to structural features and/or methods, it is to be understood that the invention is not necessarily limited to the specific features or methods described. Rather, the specific features and methods are disclosed and explained in the context of a few embodiments for task assignment in crowdsourcing.

We claim:

1. A crowdsourcing system (102) comprising:
a processor (110):
a task receipt module (120) coupled to the processor (110), the task receipt module (120) configured to receive task information from a requester, the task information comprising at least details of a task, an accuracy level for task completion, and a budget for the task; and
a task assignment module (122) coupled to the processor (110), the task assignment module (122) configured to recommend an assignment of the task to agents based on a comparison of expected costs of completing the task to achieve the accuracy level within the budget.

2. The crowdsourcing system (102) as claimed in claim 1, wherein the task assignment module (122) is configured to recommend one of a random assignment, an oracle assignment and a referral based assignment as the assignment.

3. The crowdsourcing system (102) as claimed in claim 2, wherein the task assignment module (122) is configured to recommend one of a referral assignment, a random-referral hybrid assignment and an oracle-referral hybrid assignment as the referral based assignment.

4. The crowdsourcing system (102) as claimed in claim 1, wherein the task assignment module (122) is configured to determine an upper bound on a referral payment for the task when a referral based assignment is recommended for completing the task.

5. The crowdsourcing system (102) as claimed in claim 1, wherein the task assignment module (122) is configured to compute the expected costs based on the task information and an agent capability distribution.

6. The crowdsourcing system (102) as claimed in claim 1, wherein
the task receipt module (120) is configured to receive an agent criteria comprising minimum qualifications for an agent to attempt the task; and
the task assignment module (122) is configured to pre-screen the agents based on the agent criteria.

7. The crowdsourcing system (102) as claimed in claim 1 further comprising a solution aggregation module (124) coupled to the processor (110), the solution aggregation module (124) configured to receive solutions from the agents and determine an aggregate solution for the task.

8. A method for task assignment in crowdsourcing, the method comprising:
receiving task information from a requester, the task information comprising at least details of a task, an accuracy level for task completion, and a budget for the task;
computing expected costs of completing the task to achieve the accuracy level within the budget based on the task information; and
recommending an assignment of the task to agents based on the computation.

9. The method as claimed in claim 8, wherein the recommending the assignment comprises recommending one of an oracle assignment, a random assignment, a referral assignment, and a hybrid assignment.

10. The method as claimed in claim 9, wherein the hybrid assignment comprises:
selecting a seed set based on one of the oracle assignment and the random assignment; and
assigning the task to the seed set at least for referral.

11. The method as claimed in claim 8 further comprising determining an upper bound on a referral payment for the task when a referral based assignment is recommended for completing the task.

12. The method as claimed in claim 8, wherein the computing the expected costs comprises selecting an agent capability distribution based at least in part on past performance of the agents.

13. The method as claimed in claim 8 further comprising receiving an agent criteria comprising minimum qualifications for an agent to attempt the task; and pre-screening an agent pool based on the agent criteria.

14. The method as claimed in claim 8 further comprising receiving solutions from the agents and determining an aggregate solution for the task.

15. A non-transitory computer readable medium (304) comprising instructions executable by a processor to;
receive task information from a requester, the task information comprising at least details of a task, an accuracy level for task completion, and a budget for the task;
compute expected costs of completing the task to achieve the accuracy level within the budget based on the task information and an agent capability distribution; and
recommend an assignment of the task to agents based on the computation.

16. The non-transitory computer readable medium (304) as claimed in claim 15, wherein the assignment is one of a random assignment, an oracle assignment, a referral assignment, a random-referral hybrid assignment and an oracle-referral hybrid assignment.

17. The non-transitory computer readable medium (304) as claimed in claim 15, wherein the set of computer readable instructions, when executed, perform further acts to determine an upper bound on a referral payment for the task when a referral based assignment is recommended for completing the task.
